(19) United States
(12) Patent Application Publication
(10) Pub. No.: US 2025/0389815 A1
(43) Pub. Date: Dec. 25, 2025

(54) DEVICE AND METHOD FOR CORRECTING RADAR SIGNAL

(71) Applicant: HL Klemove Corp., Incheon (KR)

(72) Inventor: Joung Chel MOON, Incheon (KR)

(73) Assignee: HL Klemove Corp., Incheon (KR)

(21) Appl. No.: 18/920,328

(22) Filed: Oct. 18, 2024

(30) Foreign Application Priority Data
Jun. 20, 2024 (KR) 10-2024-0080047

(51) Int. Cl. G01S 7/40; G01S 13/931

(52) U.S. Cl. CPC G01S 7/4039; G01S 7/4008; G01S 13/931; G01S 2013/93271

(57) ABSTRACT

The present embodiments relate to a radar signal correction device and method capable of correcting distortion of a radar signal due to deformation of a bumper using moving object.

### CROSS-REFERENCE TO RELATED APPLICATION

This application claims priority from Korean Patent Application No. 10-2024-0080047, filed on Jun. 20, 2024, which is hereby incorporated by reference for all purposes as if fully set forth herein.

### BACKGROUND

### Field

The present embodiments relate to a radar signal correction device and method capable of correcting a radar signal.

### Description of Related Art

As autonomous driving technology advances, vehicles are being equipped with cutting-edge technologies, such as a driver assistance system (DAS). To implement cutting-edge technologies, such as driver assistance systems, accurate information about surrounding objects is required. To that end, various detection devices are installed in vehicles. In order for a radar mounted on a vehicle to perform various functions, the accuracy of the information input from the radar is required.

Radars are installed at the front and rear of the vehicle to obtain information. Typically, radars are installed inside the front and rear bumpers of a vehicle. Here, if the bumper is deformed due to an accident or other reasons, the radar may obtain incorrect information about surrounding objects due to distortion of the radar signal caused by the deformation of the bumper.

Accordingly, a specific design is required for a technology capable of correcting distortion of radar signals due to deformation of the bumper shape using a moving object.

### BRIEF SUMMARY

In the foregoing background, there may be provided a radar signal correction device and method capable of correcting distortion of a radar signal due to deformation of a bumper using a moving object.

In an aspect, the present embodiments may provide a radar signal correction device comprising a determiner determining a driving state of a vehicle based on driving information about the vehicle, an obtainer obtaining lane information about a lane where the vehicle is driving, a reflection signal obtained as a radar signal emitted from a radar mounted to the vehicle is reflected by a target, and bumper shape information corresponding to a bumper mounted to the vehicle, a setter obtaining target information based on the reflection signal and the bumper shape information and setting a moving target based on the driving information and the target information, and a controller determining whether the driving lane of the vehicle and a driving lane of the moving target are the same lane based on a location of the moving target, calculating a correction angle based on the location of the moving target driving the same lane as the driving lane of the vehicle and a location where the radar is mounted, and updating the bumper shape information based on the correction angle.

In another aspect, the present embodiments may provide a radar signal correction method comprising determining a driving state of a vehicle based on driving information about the vehicle, obtaining lane information about a lane where the vehicle is driving, a reflection signal obtained as a radar signal emitted from a radar mounted to the vehicle is reflected by a target, and bumper shape information corresponding to a bumper mounted to the vehicle, obtaining target information based on the reflection signal and the bumper shape information and setting a moving target based on the driving information and the target information, and determining whether the driving lane of the vehicle and a driving lane of the moving target are the same lane based on a location of the moving target, calculating a correction angle based on the location of the moving target driving the same lane as the driving lane of the vehicle and a location where the radar is mounted, and updating the bumper shape information based on the correction angle.

According to the present embodiments, there may be provided a radar signal correction device and method capable of correcting distortion of a radar signal due to deformation of a bumper using a moving object.

### DESCRIPTION OF DRAWINGS

The above and other objects, features, and advantages of the disclosure will be more clearly understood from the following detailed description, taken in conjunction with the accompanying drawings, in which:

FIG. 1 is a view illustrating a radar signal correction device according to the present embodiments;

FIG. 2 is a view illustrating distortion of a reflection signal due to a bumper according to the present embodiments;

FIG. 3 is a view illustrating a correction angle according to the present embodiments;

FIG. 4 is a view illustrating a radar signal correction step according to the present embodiments;

FIG. 5 is a view illustrating a method for setting a moving target according to the present embodiments; and

FIG. 6 is a view illustrating a method for updating bumper shape information according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, a radar signal correction device and method according to embodiments of the disclosure is described with reference to the related drawings.

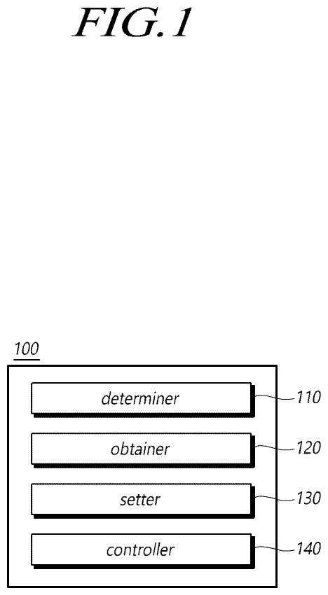

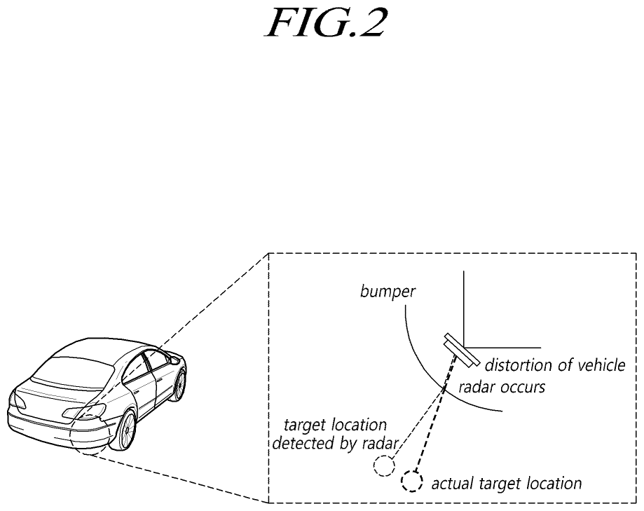

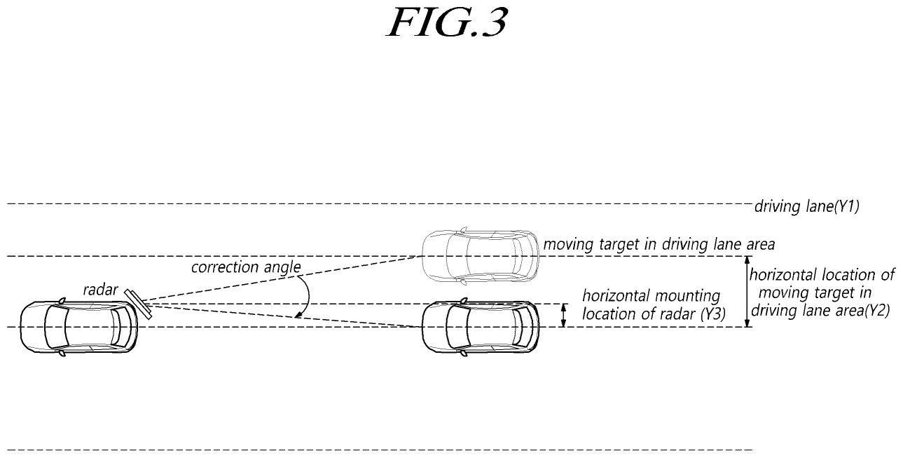

FIG. 1 is a view illustrating a radar signal correction device according to the present embodiments. FIG. 2 is a view illustrating distortion of a reflection signal due to a bumper according to the present embodiments. FIG. 3 is a view illustrating a correction angle according to the present embodiments.

Referring to FIG. 1, a radar signal correction device 100 according to an embodiment may include a determiner 110 determining a driving state of a vehicle based on driving information about the vehicle, an obtainer 120 obtaining lane information about a lane where the vehicle is driving, a reflection signal obtained as a radar signal emitted from a radar mounted to the vehicle is reflected by a target, and bumper shape information corresponding to a bumper mounted to the vehicle, a setter 130 obtaining target information based on the reflection signal and the bumper shape information and setting a moving target based on the driving information and the target information, and a controller 140 determining whether the driving lane of the vehicle and a driving lane of the moving target are the same lane based on a location of the moving target, calculating a correction angle based on the location of the moving target driving the same lane as the driving lane of the vehicle and a location where the radar is mounted, and updating the bumper shape information based on the correction angle.

The radar signal correction device 100 according to an embodiment may be implemented as an electronic control unit (ECU) including at least one micro control unit (MCU), a printed circuit board (PCB), etc.

The radar signal correction device 100 may perform communication using at least one of a control area network (CAN), FlexrRay, and a local interconnect network (LIN) which are shared communication channels for vehicles. However, this is merely an example, and embodiments of the disclosure are not limited thereto. The communication channel may be configured variously as necessary unless contradictory to the technical spirit of the disclosure.

However, the configuration of the radar signal correction device 100 illustrated in FIG. 1 is merely an example, and the disclosure is not limited thereto. The radar signal correction device 100 may further include other components, or some components may be omitted, if necessary. In this case, according to an example, components of the radar signal correction device 100 may be combined with each other or some components may be omitted according to the communication structure design scheme.

Referring back to FIG. 1, the determiner 110 may obtain driving information about the vehicle from a sensor mounted to the vehicle. Here, the driving information refers to information sensed by the sensor mounted to the vehicle, and may include, e.g., steering torque information, vehicle velocity information, and yaw rate information.

Specifically, the torque sensor may detect the steering torque generated by rotation of the steering wheel. If the steering torque is detected, the torque sensor may output a steering torque signal corresponding to the information about the steering torque. The determiner 110 may receive the steering torque signal to obtain steering torque information.

Further, the velocity sensor may detect the velocity of the vehicle and output a vehicle velocity signal corresponding to the vehicle velocity information. The determiner 110 may obtain the velocity information about the vehicle by receiving the vehicle velocity signal.

Further, the yaw rate sensor may output a yaw rate signal corresponding to information about yaw motion of the vehicle. The determiner 110 may receive the yaw rate signal and obtain the yaw rate information about the vehicle.

Referring back to FIG. 1, the determiner 110 may determine the driving state of the vehicle based on the driving information about the vehicle. According to an embodiment, the determiner 110 may determine whether the vehicle is driving straight based on driving information obtained from each sensor. For example, the determiner 110 may determine whether the vehicle drives straight based on the yaw rate information and the vehicle velocity information. If the vehicle drives straight without rotating, the yaw rate sensor may output a yaw rate signal when the vehicle drives straight without rotating. Accordingly, the determiner 110 may determine whether the vehicle drives straight based on the vehicle velocity information and the yaw rate information about the vehicle.

Further, the determiner 110 may enhance the reliability of determining whether to drive straight based on the steering torque information. In the case of straight driving, rotation of the steering wheel may not be required. The torque sensor may output a steering torque signal corresponding to the straight driving. Accordingly, the determiner 110 may enhance reliability of determination as to whether the vehicle drives straight.

However, this is merely an example for describing the method of determining the driving state of the vehicle based on driving information about the vehicle and enhancing reliability of the determination, and the disclosure is not limited thereto. The method for determining the driving state of the vehicle based on the driving information may be variously performed as necessary, unless contradictory to the technical spirit of the disclosure.

Referring back to FIG. 1, when it is determined that the driving state of the vehicle is straight driving, the obtainer 120 may obtain lane information about a lane where the vehicle is driving, a reflection signal obtained as a radar signal emitted from a radar mounted to the vehicle is reflected by a target, and bumper shape information corresponding to a bumper mounted to the vehicle.

Referring to FIG. 2, the determiner 110 may obtain the bumper shape information. The reflection signal may be distorted depending on the shape of the bumper. In other words, information about the target may be distorted according to the distortion of the reflection signal. In order to obtain accurate information about the target, distortion according to the shape of the bumper should be corrected. The bumper shape information may include information capable of correcting distortion of the reflection signal according to the shape of the bumper. The bumper shape information according to an example may be preset in a radar arrangement step during the vehicle release process.

Referring back to FIG. 1, the obtainer 120 may obtain lane information corresponding to the lane where the vehicle is driving. For example, the obtainer 120 may obtain lane information obtained by a camera mounted to the vehicle. In other words, the lane information may include information corresponding to the width of the lane being driven.

However, this is merely an example for describing a method for obtaining lane information, and the disclosure is not limited thereto. The method for obtaining the lane information may be variously performed as necessary, unless contradictory to the technical spirit of the disclosure, and follows the known art.

Referring back to FIG. 1, the obtainer 120 may obtain the reflection signal of the radar signal emitted from the radar mounted to the vehicle, reflected by the target. The reflection signal may include Doppler information about the target.

For example, the Doppler information may include the frequency value of the radar signal for the target, the time when the reflection signal corresponding to the radar signal for the target is received, and the frequency value of the reflection signal received from the target. Further, the radar signal may include a radar cross section (RCS) value for the target. The RCS value may refer to a value indicating the magnitude of the reflection signal returned after the radar signal transmitted from the radar is reflected by the target in a of the area.

In other words, the reflection signal may include information about the target. The determiner 110 may obtain information about the target based on the reflection signal and the bumper shape information.

Referring back to FIG. 1, the setter 130 may obtain target information based on the reflection signal and bumper shape information. In other words, the setter 130 may correct the distortion of the reflection signal according to the shape of the bumper based on the previously stored bumper shape information. The setter 130 may obtain accurate target information based on the corrected reflection signal.

Here, the target information may include a distance to the target, a velocity of the target, and an angle with the target with respect to the radar obtaining the reflection signal. The method for obtaining target information for the target based on the reflection signal follows the known art, and the detailed description thereof will be omitted.

The setter 130 may set a moving target based on driving information and target information about the vehicle. The setter 130 may compare the driving information about the vehicle with the target information to set the target, which is moving, as the moving target.

In an embodiment, the setter 130 may set the moving target based on the difference between the velocity of the vehicle and the velocity of the target. In other words, the setter 130 may calculate a relative velocity of the vehicle and the moving target, and set the moving target based on the relative velocity.

However, this is an embodiment for describing a method for setting a moving target, and is not limited thereto. There may be various methods for determining a moving target by the setter 130 based on the driving information and the target information about the vehicle, and the known art is followed.

The controller 140 may obtain the location of the moving target based on the target information about the set moving target. The controller 140 may determine the driving lane where the moving target is driving based on the lane information about the driving lane where the vehicle is driving and the location of the moving target. In other words, the controller 140 may determine whether the moving target drives in the same lane as the lane where the vehicle drives or in a lane different from the lane where the vehicle drives.

Here, the location of the moving target may be a horizontal location measured perpendicular to the center line of the vehicle with respect to the center line of the vehicle parallel to the driving lane.

Specifically, the controller 140 may set the center line of the vehicle parallel to the driving lane of the vehicle as the X-axis, and set the line perpendicular to the center line of the vehicle as the Y-axis. The controller 140 may set the location of the lane of the host vehicle as a coordinate value (X1, Y1), and set the location of the moving target as a coordinate value (X2, Y2). The controller 140 may determine the driving lane of the moving target based on the coordinate values Y1 and Y2. In other words, the driving lane of the moving target may be determined based on the difference between Y1 and Y2.

If it is determined that the moving target drives in a lane different from the lane where the vehicle drives, the setter 130 may set another target as the moving target.

If it is determined that the moving target drives in the same lane as the lane where the vehicle drives, the controller 140 may calculate the correction angle based on the location of the moving target and the mounting location of the radar. Specifically, when the difference between the location of the moving target and the mounting location of the radar exceeds a predetermined threshold, the controller 140 may calculate the correction angle.

In general, when a vehicle drives straight in a lane, the vehicle drives about the center of the driving lane. Likewise, the moving target driving in the same lane may travel with respect to the center of the driving lane. Accordingly, if the location of the moving target driving in the straight lane is continuously obtained as a location off the center of the driving lane, the controller 140 may determine that the radar signal is distorted by the shape of the bumper. In this case, the controller 140 may calculate the correction angle and update the bumper shape information based on the correction angle.

A method for the controller 140 to calculate the correction angle based on the location of the moving target and the mounting location of the radar is described in detail with reference to FIG. 3. Referring to FIG. 3, the controller 140 may calculate the correction angle based on the location of the moving target and the mounting location of the radar.

The controller 140 may set the center line of the vehicle parallel to the driving lane of the vehicle as the X-axis, and set the line perpendicular to the center line of the vehicle as the Y-axis. The controller 140 may obtain the location where the radar is mounted as a coordinate value (X3, Y3). If the difference between the coordinate values Y2 and Y3 exceeds a predetermined threshold, the controller 140 may calculate a correction angle.

The controller 140 may update the bumper shape information based on the correction angle. The controller 140 may reflect the calculated correction angle to the bumper shape information. Thereafter, the obtainer 120 may obtain target information based on the updated bumper shape information.

Accordingly, it is possible to provide a radar signal correction device capable of correcting distortion of a radar signal due to deformation of a bumper shape using a moving object.

Hereinafter, a radar signal correction method capable of performing some or all of the embodiments described with reference to FIGS. 1 to 3 is described with reference to the drawings. The above-described description may be omitted to avoid redundant description and, in that case, the omitted content may be applied in substantially the same manner to the following description as long as it does not go against the technical spirit of the disclosure.

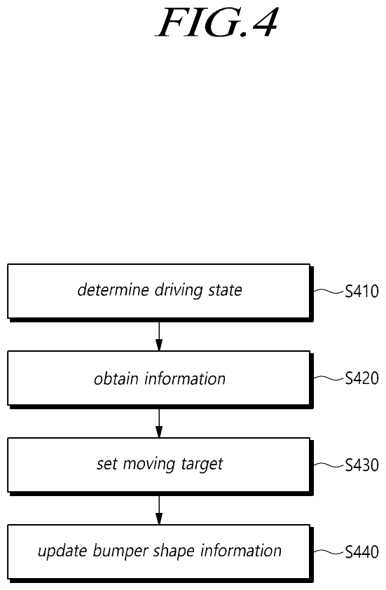

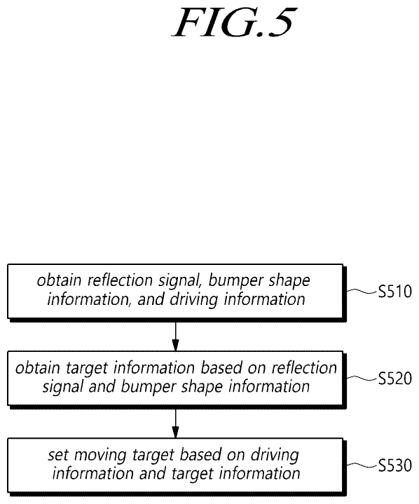

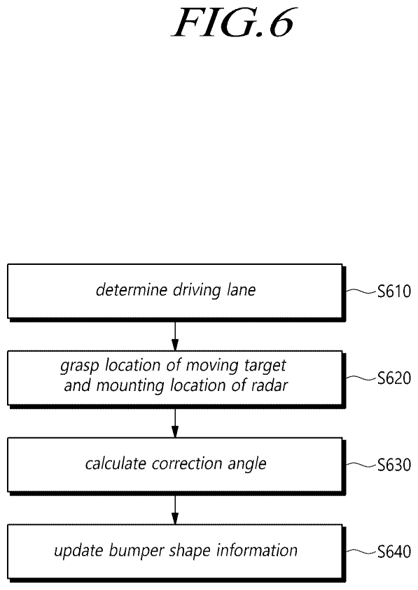

FIG. 4 is a view illustrating a radar signal correction step according to the present embodiments. FIG. 5 is a view illustrating a method for setting a moving target according to the present embodiments. FIG. 6 is a view illustrating a method for updating bumper shape information according to the present embodiments.

Referring to FIG. 4, the radar signal correction device may obtain driving information about the vehicle from a sensor mounted to the vehicle. Here, the driving information refers to information sensed by the sensor mounted to the vehicle, and may include, e.g., steering torque information, vehicle velocity information, and yaw rate information.

Specifically, the torque sensor may detect the steering torque generated by rotation of the steering wheel. If the steering torque is detected, the torque sensor may output a steering torque signal corresponding to the information about the steering torque. The radar signal correction device may receive the steering torque signal to obtain steering torque information.

Further, the velocity sensor may detect the velocity of the vehicle and output a vehicle velocity signal corresponding to the vehicle velocity information. The radar signal correction device may obtain the velocity information about the vehicle by receiving the vehicle velocity signal.

Further, the yaw rate sensor may output a yaw rate signal corresponding to information about yaw motion of the vehicle. The radar signal correction device may receive the yaw rate signal and obtain the yaw rate information about the vehicle.

Referring back to FIG. 4, the radar signal correction device may determine the driving state of the vehicle based on the driving information about the vehicle (S410). According to an embodiment, the radar signal correction device may determine whether the vehicle is driving straight based on driving information obtained from each sensor. For example, the radar signal correction device may determine whether the vehicle drives straight based on the yaw rate information and the vehicle velocity information. If the vehicle drives straight without rotating, the yaw rate sensor may output a yaw rate signal when the vehicle drives straight without rotating. Accordingly, the radar signal correction device may determine whether the vehicle drives straight based on the vehicle velocity information and the yaw rate information about the vehicle.

Further, the radar signal correction device may enhance the reliability of determining whether to drive straight based on the steering torque information. In the case of straight driving, rotation of the steering wheel may not be required. The torque sensor may output a steering torque signal corresponding to the straight driving. Accordingly, the radar signal correction device may enhance reliability of determination as to whether the vehicle drives straight.

However, this is merely an example for describing the method of determining the driving state of the vehicle based on driving information about the vehicle and enhancing reliability of the determination, and the disclosure is not limited thereto. The method for determining the driving state of the vehicle based on the driving information may be variously performed as necessary, unless contradictory to the technical spirit of the disclosure.

Referring back to FIG. 4, when it is determined that the driving state of the vehicle is straight driving, the radar signal correction device may obtain lane information about a lane where the vehicle is driving, a reflection signal obtained as a radar signal emitted from a radar mounted to the vehicle is reflected by a target, and bumper shape information corresponding to a bumper mounted to the vehicle (S420).

Referring to FIG. 5, the radar signal correction device may obtain the bumper shape information (S510). The reflection signal may be distorted depending on the shape of the bumper. In other words, information about the target may be distorted according to the distortion of the reflection signal. In order to obtain accurate information about the target, distortion according to the shape of the bumper should be corrected. The bumper shape information may include information capable of correcting distortion of the reflection signal according to the shape of the bumper. The bumper shape information according to an example may be preset in a radar arrangement step during the vehicle release process.

Referring back to FIG. 5, the radar signal correction device may obtain lane information corresponding to the lane where the vehicle is driving (S510). For example, the radar signal correction device may obtain lane information obtained by a camera mounted to the vehicle. In other words, the lane information may include information corresponding to the width of the lane being driven.

However, this is merely an example for describing a method for obtaining lane information, and the disclosure is not limited thereto. The method for obtaining the lane information may be variously performed as necessary, unless contradictory to the technical spirit of the disclosure, and follows the known art.

The radar signal correction device may obtain the reflection signal of the radar signal emitted from the radar mounted to the vehicle, reflected by the target (S510). The reflection signal may include Doppler information about the target.

For example, the Doppler information may include the frequency value of the radar signal for the target, the time when the reflection signal corresponding to the radar signal for the target is received, and the frequency value of the reflection signal received from the target. Further, the radar signal may include a radar cross section (RCS) value for the target. The RCS value may refer to a value indicating the magnitude of the reflection signal returned after the radar signal transmitted from the radar is reflected by the target in a of the area.

In other words, the reflection signal may include information about the target. The radar signal correction device may obtain information about the target based on the reflection signal and the bumper shape information (S520).

The radar signal correction device may obtain target information based on the reflection signal and the bumper shape information. In other words, the radar signal correction device may correct the distortion of the reflection signal according to the shape of the bumper based on the previously stored bumper shape information. The radar signal correction device may obtain accurate target information based on the corrected reflection signal.

Here, the target information may include a distance to the target, a velocity of the target, and an angle with the target with respect to the radar obtaining the reflection signal. The method for obtaining target information for the target based on the reflection signal follows the known art, and the detailed description thereof will be omitted.

The radar signal correction device may set a moving target based on the vehicle driving information and target information (S430, S530). The radar signal correction device may compare the driving information about the vehicle with the target information to set the target, which is moving, as the moving target.

In an embodiment, the radar signal correction device may set the moving target based on the difference between the velocity of the vehicle and the velocity of the target. In other words, the radar signal correction device may calculate a relative velocity of the vehicle and the moving target, and set the moving target based on the relative velocity.

However, this is an embodiment for describing a method for setting a moving target, and is not limited thereto. There may be various methods for determining a moving target by the radar signal correction device based on the driving information and the target information about the vehicle, and the known art is followed.

The radar signal correction device may obtain the location of the moving target based on the target information about the set moving target. Referring to FIG. 6, the radar signal correction device may determine the driving lane where the moving target is driving based on the lane information about the driving lane where the vehicle is driving and the location of the moving target (S610). In other words, the radar signal correction device may determine whether the moving target drives in the same lane as the lane where the vehicle drives or in a lane different from the lane where the vehicle drives.

Here, the location of the moving target may be a horizontal location measured perpendicular to the center line of the vehicle with respect to the center line of the vehicle parallel to the driving lane.

Specifically, the radar signal correction device may set the center line of the vehicle parallel to the driving lane of the vehicle as the X-axis, and set the line perpendicular to the center line of the vehicle as the Y-axis. The radar signal correction device may set the location of the lane of the host vehicle as a coordinate value (X1, Y1), and set the location of the moving target as a coordinate value (X2, Y2). The radar signal correction device may determine the driving lane of the moving target based on the coordinate values Y1 and Y2. In other words, the driving lane of the moving target may be determined based on the difference between Y1 and Y2.

If it is determined that the moving target drives in a lane different from the lane where the vehicle drives, the radar signal correction device may set another target as the moving target.

If it is determined that the moving target drives in the same lane as the lane where the vehicle drives, the radar signal correction device may calculate the correction angle based on the location of the moving target and the mounting location of the radar (S620). Specifically, when the difference between the location of the moving target and the mounting location of the radar exceeds a predetermined threshold, the radar signal correction device may calculate the correction angle (S630).

In general, when a vehicle drives straight in a lane, the vehicle drives about the center of the driving lane. Likewise, the moving target driving in the same lane may travel with respect to the center of the driving lane. Accordingly, if the location of the moving target driving in the straight lane is continuously obtained as a location off the center of the driving lane, the radar signal correction device may determine that the radar signal is distorted by the shape of the bumper. In this case, the radar signal correction device may calculate the correction angle and update the bumper shape information based on the correction angle.

The radar signal correction device may set the center line of the vehicle parallel to the driving lane of the vehicle as the X-axis, and set the line perpendicular to the center line of the vehicle as the Y-axis. The radar signal correction device may obtain the location where the radar is mounted as a coordinate value (X3, Y3). If the difference between the coordinate values Y2 and Y3 exceeds a predetermined threshold, the radar signal correction device may calculate a correction angle.

The radar signal correction device may update bumper shape information based on the correction angle (S440, S640). The radar signal correction device may reflect the calculated correction angle to the bumper shape information. Thereafter, the radar signal correction device may obtain target information based on the updated bumper shape information.

Accordingly, it is possible to provide a radar signal correction method capable of correcting distortion of a radar signal due to deformation of a bumper shape using a moving object.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A radar signal correction device, comprising:
a determiner determining a driving state of a vehicle based on driving information about the vehicle;
an obtainer obtaining lane information about a lane where the vehicle is driving, a reflection signal obtained as a radar signal emitted from a radar mounted to the vehicle is reflected by a target, and bumper shape information corresponding to a bumper mounted to the vehicle;
a setter obtaining target information based on the reflection signal and the bumper shape information and setting a moving target based on the driving information and the target information; and
a controller determining whether the driving lane of the vehicle and a driving lane of the moving target are the same lane based on a location of the moving target, calculating a correction angle based on the location of the moving target driving the same lane as the driving lane of the vehicle and a location where the radar is mounted, and updating the bumper shape information based on the correction angle.

2. The radar signal correction device of claim 1, wherein the driving information includes a velocity and a yaw rate of the vehicle.

3. The radar signal correction device of claim 1, wherein the target information includes a distance to the target, a velocity of the target, and an angle to the target with respect to the radar.

4. The radar signal correction device of claim 1, wherein the setter corrects distortion of the reflection signal generated by the bumper based on the bumper shape information.

5. The radar signal correction device of claim 1, wherein the setter sets the moving target based on a difference between a velocity of the vehicle and a velocity of the target.

6. The radar signal correction device of claim 1, wherein the location of the moving target and the location where the radar is mounted are horizontal locations measured perpendicular to a center line of the vehicle with respect to the center line parallel to the driving lane.

7. The radar signal correction device of claim 6, wherein the controller calculates the correction angle when a difference between the location of the moving target and the location where the radar is mounted exceeds a predetermined threshold.

8. A radar signal correction method, comprising:
determining a driving state of a vehicle based on driving information about the vehicle;
obtaining lane information about a lane where the vehicle is driving, a reflection signal obtained as a radar signal emitted from a radar mounted to the vehicle is reflected by a target, and bumper shape information corresponding to a bumper mounted to the vehicle;
obtaining target information based on the reflection signal and the bumper shape information and setting a moving target based on the driving information and the target information; and
determining whether the driving lane of the vehicle and a driving lane of the moving target are the same lane based on a location of the moving target, calculating a correction angle based on the location of the moving target driving the same lane as the driving lane of the vehicle and a location where the radar is mounted, and updating the bumper shape information based on the correction angle.

9. The radar signal correction method of claim 8, wherein the driving information includes a velocity and a yaw rate of the vehicle.

10. The radar signal correction method of claim 8, wherein the target information includes a distance to the target, a velocity of the target, and an angle to the target with respect to the radar.

11. The radar signal correction method of claim 8, wherein setting the moving target corrects distortion of the reflection signal generated by the bumper based on the bumper shape information.

12. The radar signal correction method of claim 8, wherein setting the moving target sets the moving target based on a difference between a velocity of the vehicle and a velocity of the target.

13. The radar signal correction method of claim 8, wherein the location of the moving target and the location where the radar is mounted are horizontal locations measured perpendicular to a center line of the vehicle with respect to the center line parallel to the driving lane.

14. The radar signal correction method of claim 13, wherein updating the bumper shape information calculates the correction angle when a difference between the location of the moving target and the location where the radar is mounted exceeds a predetermined threshold.
